(19) United States
(12) Patent Application Publication
(10) Pub. No.: US 2015/0093615 A1
(43) Pub. Date: Apr. 2, 2015

(54) POWER SUPPLY DEVICE

(71) Applicant: Yazaki Corporation, Minato-ku, Tokyo (JP)

(72) Inventor: Nobuaki Yoshioka, Kakegawa-shi (JP)

(73) Assignee: Yazaki Corporation, Minato-ku, Tokyo (JP)

(21) Appl. No.: 14/389,813

(22) PCT Filed: Mar. 22, 2013
(86) PCT No.: PCT/JP2013/001966

§ 371 Date: Oct. 1, 2014

(30) Foreign Application Priority Data
Apr. 5, 2012 (JP) 2012-086500

(51) Int. Cl. H01M 2/10; H01M 10/48; H01M 2/30

(52) U.S. Cl. CPC H01M 2/1072; H01M 2/305; H01M 10/482
USPC 429/93

(57) ABSTRACT

A power supply device (A) comprising a battery assembly (1) in which a plurality of battery cells (2) and (3) having electrodes (2b) and (3b) projected is stacked, a battery coupling block body (10) disposed on a side of the battery assembly (1) where the electrodes (2b) and (3b) are projected and having a substrate (12) provided with a circuit pattern part for voltage detection and provided with a terminal insertion hole (14), battery-side-relay terminals (16) and (17) connected to the electrodes (2b) and (3b) of the battery cells (2) and (3) and projected from the terminal insertion holes (14) to an outer surface side of the substrate (12), a substrate-side-relay terminal (18) connected to the circuit pattern part for voltage detection and projected to the outer surface side of the substrate (12) and clips (19) clamping both of the battery-side-relay terminals (16) and (17), and the substrate-side-relay terminal (18).

### TECHNICAL FIELD

The present invention relates to a power supply device having a plurality of stacked battery cells.

### BACKGROUND ART

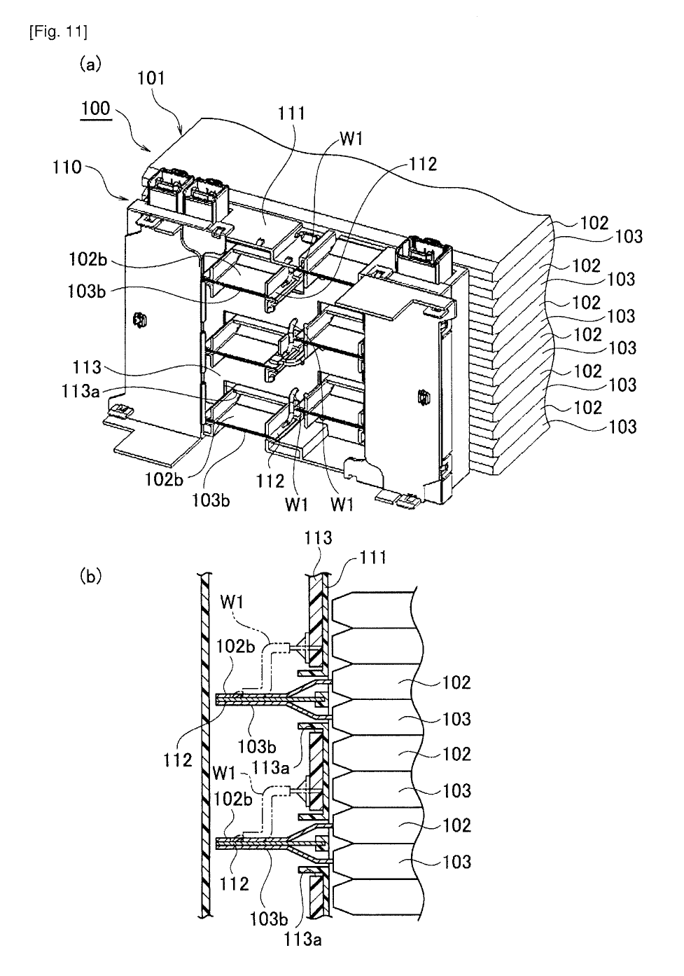

A power supply device is mounted, for example, on a hybrid vehicle or an electric vehicle as a driving source for an electric motor. Up to now, various power supply devices have been proposed (see Patent Literatures, PTL 1 and 2), and also the present applicant has proposed a power supply device shown in FIG. 11.

As shown in FIG. 11, this power supply device 100 includes a battery assembly 101 which has a plurality of stacked battery cells 102 and 103 and in which respective electrodes 102b and 103b of the adjacent battery cells 102 and 103 are disposed facing each other, and a battery coupling block body 110 disposed on a side of the battery assembly 101 where the electrodes 102b and 103b are projected.

The battery coupling block body 110 includes an insulating case body 111, a relay terminal 112 fixed to this insulating case body 111, and a substrate 113 fixed within the insulating case body 111. The relay terminal 112 is formed by a bus bar. The relay terminal 112 is projected to an outer surface side of the substrate 113. A circuit pattern part for voltage detection (not shown) is formed on the substrate 113. Electrode insertion holes 113a are formed in the substrate 113 at positions of the respective relay terminals 112. The electrodes 102b and 103b of the battery cells 102 and 103 are projected from the respective electrode insertion holes 113a to the outer surface side of the substrate 113. The respective electrodes 102b and 103b which are projected to the outer surface side of the substrate 113 are arranged in a state of overlapping with upper and lower surfaces of the relay terminal 112. The respective electrodes 102b and 103b and the relay terminal 112 are in a mutually fixed and mutually electrically coupled state. The relay terminal 112 with the electrodes 102b and 103b connected in this way is connected to the circuit pattern part for voltage detection of the substrate 113 via an electric wire W1. The relay terminal 112 and the electric wire W1 are fixed generally by soldering. With the above configuration, output states of the respective battery cells 102 and 103 can be detected.

PTL 1: Japanese Patent Application Laid-Open Publication No. 2010-055885

PTL 2: Japanese Patent Application Laid-Open Publication No. 2004-055492

### SUMMARY OF INVENTION

However, in the above mentioned conventional power supply device 100, when the battery cell 102, 103 or the substrate 113 fails or is damaged and is to be replaced, the battery assembly 101 and the battery coupling block body 110 cannot be easily dismantled due to soldering or the like between the relay terminal 112 and the electric wire W1. Therefore, both of the battery assembly 101 and the battery coupling block body 110 are integrally replaced and a problem of increasing replacement cost or the like occurred. A structure capable of solving this problem and of easily and separately replacing the battery assembly and the battery coupling block body is being demanded.

Accordingly, the present invention has been made in order to solve the above mentioned problem and aims to provide a power supply device capable of easily and separately replacing the battery assembly and the battery coupling block body.

The present invention is a power supply device characterized by including a battery assembly in which a plurality of battery cells having electrodes projected is stacked, a battery coupling block body disposed on a side of the battery assembly where the electrodes are projected and having a substrate provided with a circuit pattern part for voltage detection and provided with a terminal insertion hole, a battery-side-relay terminal connected to the electrodes of the battery cells and projected from the terminal insertion hole to an outer surface side of the substrate, a substrate-side-relay terminal connected to the circuit pattern part for voltage detection and projected to the outer surface side of the substrate, and a clip clamping both of the battery-side-relay terminal and the substrate-side-relay terminal.

It is preferable that the battery-side-relay terminal has an electrode connection part, and the electrodes are respectively fixed to both surfaces of the electrode connection part. It is preferable that the battery-side-relay terminal has a plurality of the electrode connection parts coupled by a coupling part, and the electrodes of the battery cells are respectively connected to the respective electrode connection parts. It is preferable that electrode insertion holes which open on inner surface sides of the respective electrode connection parts are provided in the coupling part.

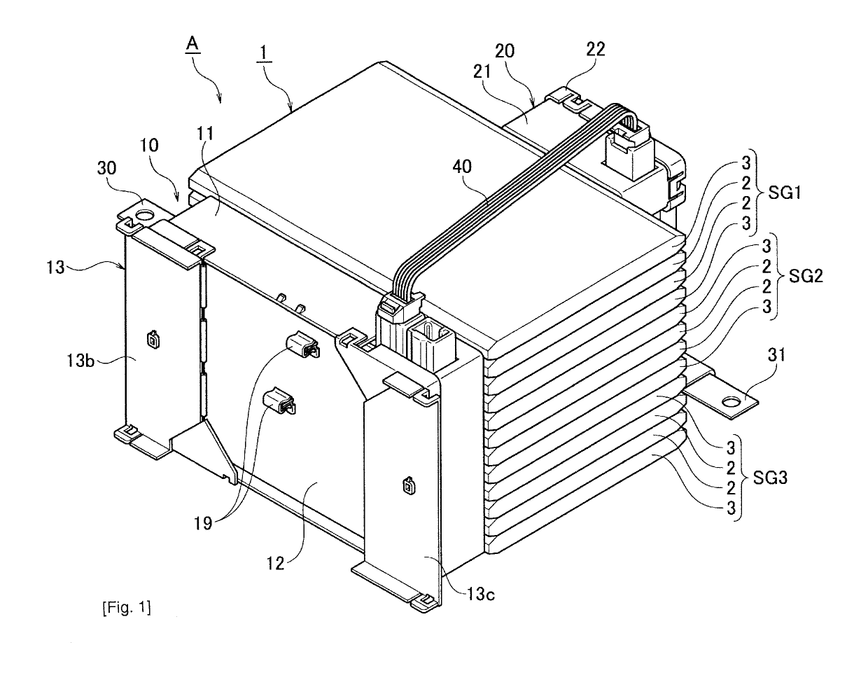

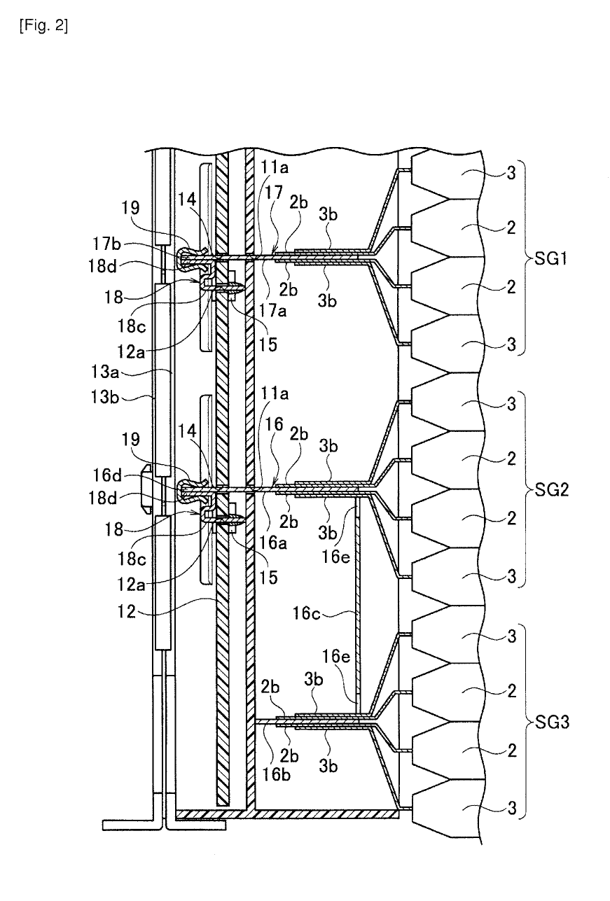

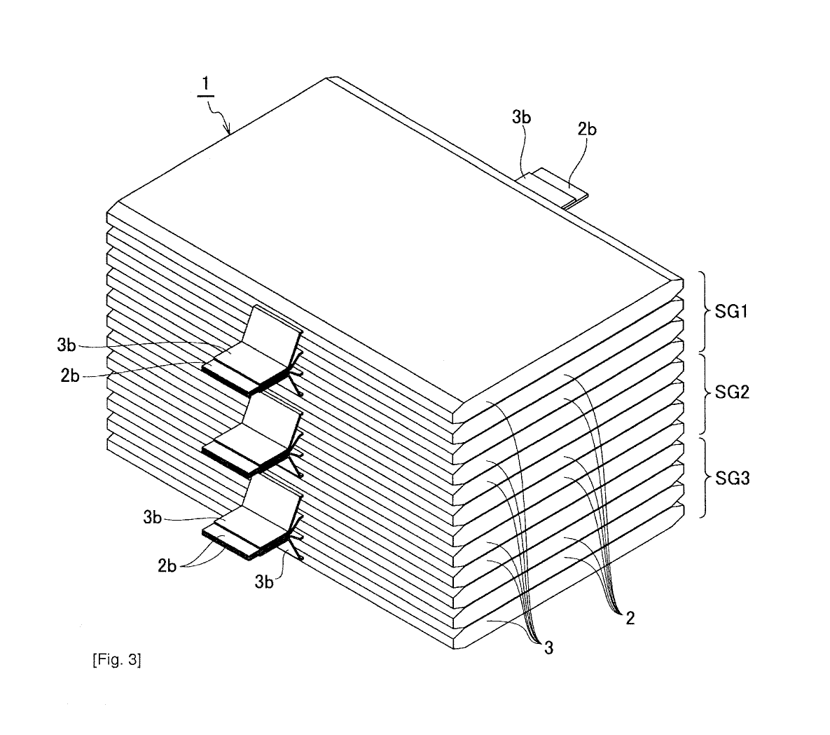

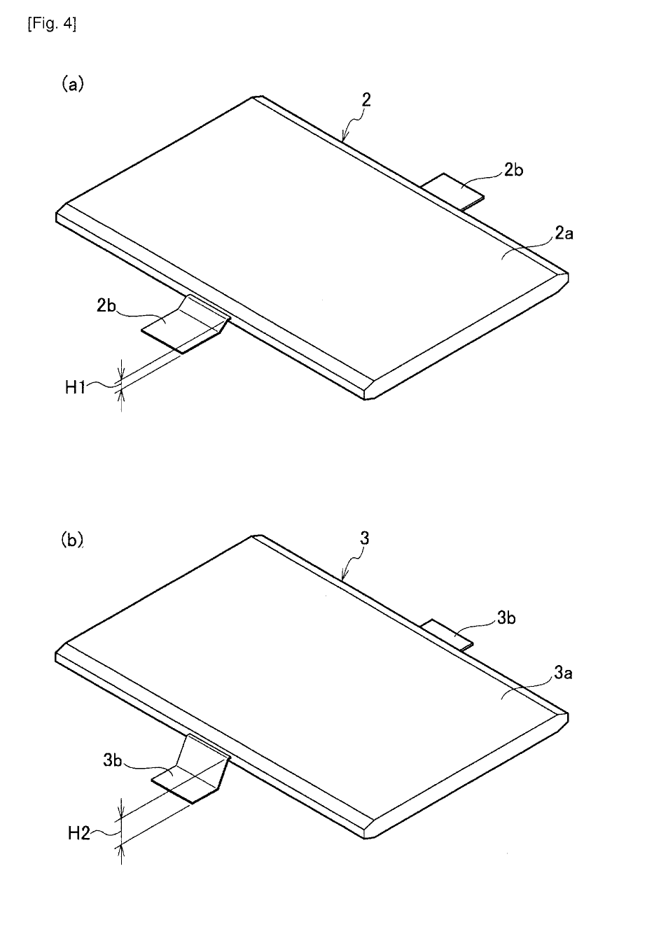

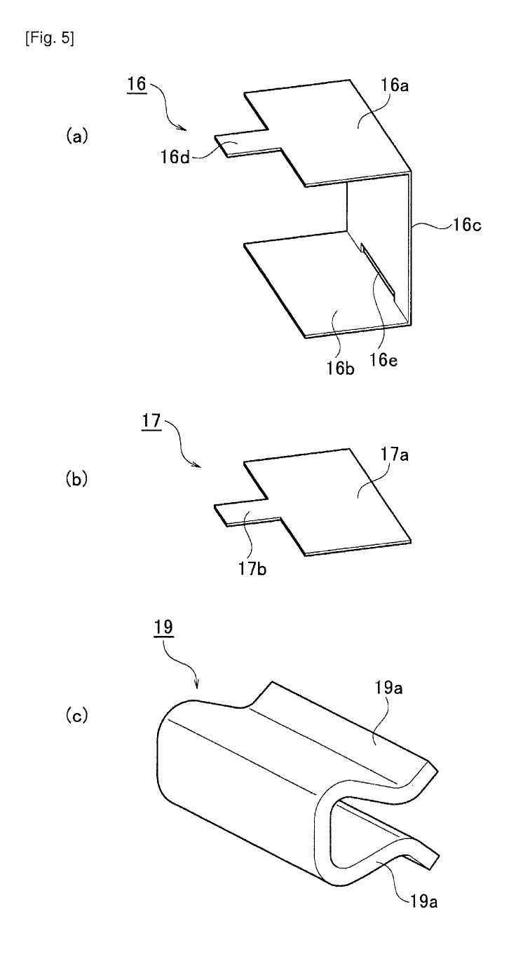

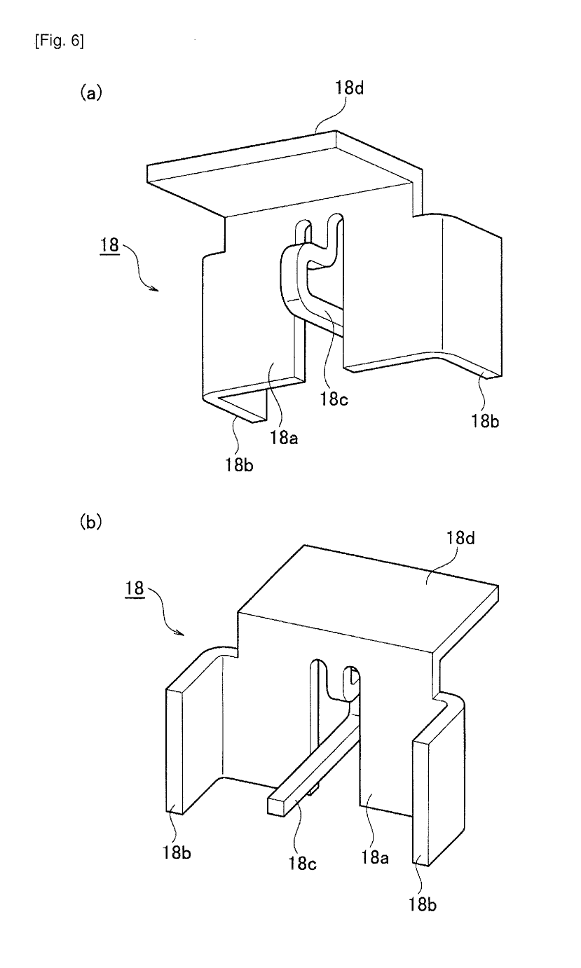

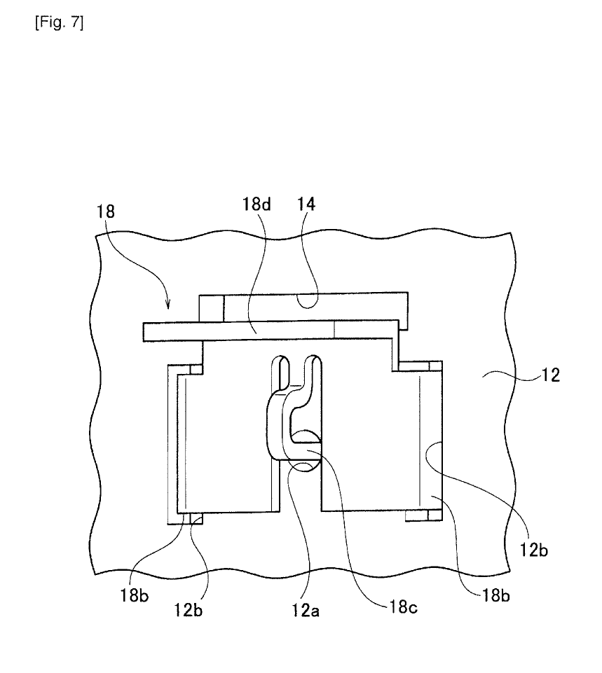

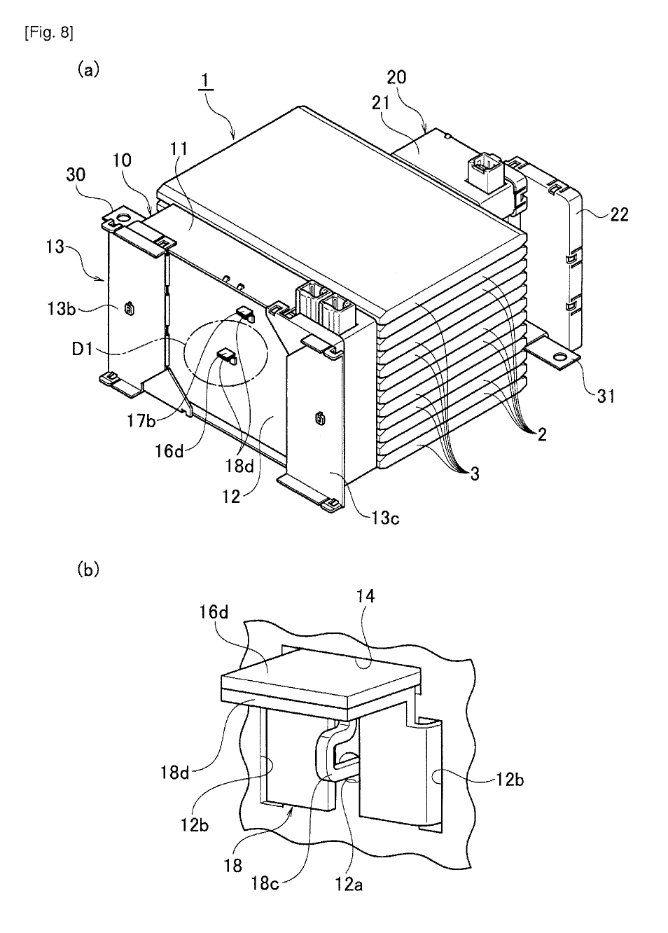

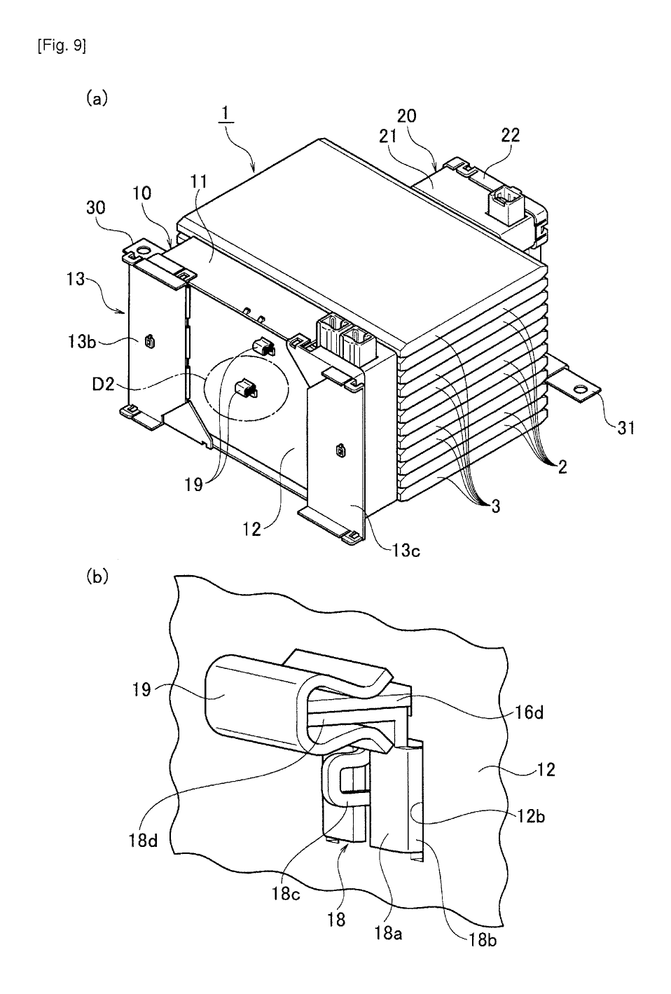

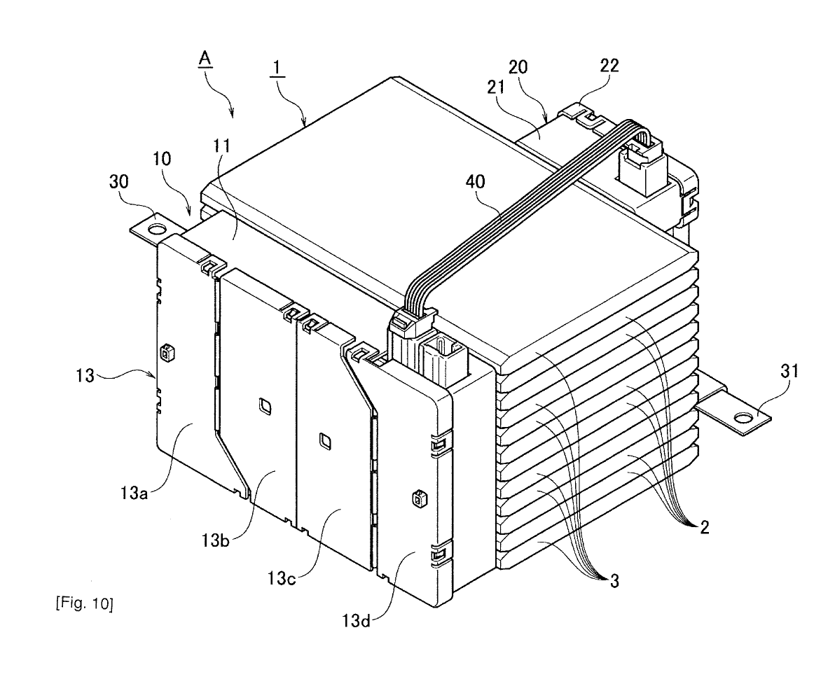

### BRIEF DESCRIPTION OF DRAWINGS

[FIG. 1]FIG. 1 is a general perspective view of a power supply device, showing one embodiment of the present invention.

[FIG. 2]FIG. 2 is an essential part sectional view showing a connection structure of electrodes of battery cells and a circuit pattern part of a substrate, showing one embodiment of the present invention.

[FIG. 3]FIG. 3 is a perspective view of a battery assembly, showing one embodiment of the present invention.

[FIG. 4]FIGS. 4(a) and 4(b) are, respectively, perspective views of a first battery cell and a second battery cell, showing one embodiment of the present invention.

[FIG. 5]FIGS. 5(a), 5(b) and 5(c) are, respectively, perspective views of a first electrode side relay terminal, a second electrode side relay terminal and a clip, showing one embodiment of the present invention.

[FIG. 6]FIGS. 6(a) and 6(b) are perspective views of substrate-side-relay terminals viewed from directions different from each other, showing one embodiment of the present invention.

[FIG. 7]FIG. 7 is a perspective view showing a state where the substrate-side-relay terminal is fixed to the substrate, showing one embodiment of the present invention.

[FIG. 8]FIG. 8(a) is a perspective view showing a process of assembling a battery assembly and a battery coupling block body, and FIG. 8(b) is an enlarged view of a D1 part in FIG. 8(a), showing one embodiment of the present invention.

[FIG. 9]FIG. 9(a) is a perspective view showing a process of assembling the battery assembly and the battery coupling block body, and FIG. 9(b) is an enlarged view of a D2 part in FIG. 9(a), showing one embodiment of the present invention.

[FIG. 10]FIG. 10 is a perspective view at the time of the completion of assembling of the battery assembly and the battery coupling block body, showing one embodiment of the present invention.

[FIG. 11]FIG. 11(a) is a perspective view of a power supply device, and FIG. 11(b) is an essential part cross-sectional view showing a connection structure of electrodes of battery cells and a circuit pattern part of a substrate, showing prior art.

### DESCRIPTION OF EMBODIMENTS

Hereinafter, an embodiment of the present invention will be described on the basis of the drawings.

FIG. 1 to FIG. 10 show one embodiment of the present invention. As shown in FIG. 1, a power supply device A includes a battery assembly 1 including a plurality (twelve) of stacked battery cells 2 and 3, one pair of battery coupling block bodies 10 and 20 disposed on both sides of this battery assembly 1, and a flat cable 40 connected between the one pair of battery coupling block bodies 10 and 20.

The battery assembly 1, as shown in detail in FIG. 3, is constituted by the twelve battery cells 2 and 3. The battery assembly 1 is divided into three sets of battery cell groups SG1, SG2 and SG3 in which four battery cells 2 and 3 are parallel-connected, and the three sets of battery cell groups SG1, SG2 and SG3 are series-connected.

As shown in FIG. 4(a), the battery cell 2 has a flat rectangular cell body 2a, and one pair of electrodes (plus electrode and minus electrode) 2b projected from left and right side faces thereof.

As shown in FIG. 4(b), the battery cell 3 has a flat rectangular cell body 3a, and one pair of electrodes (plus electrode and minus electrode) 3b projected from left and right side faces thereof.

Each of the electrodes 2b and 3b is set so as to only differ in an up-and-down direction and to be located at the same position in a planar view, even when the battery cells 2 and 3 are reversely arranged upside down. Each of the respective electrodes 2b and 3b has a thin film shape (a plate-like shape). Each of the respective electrodes 2b and 3b projects toward a rear face side.

Two kinds of battery cells which are different in projection height between their electrodes 2b and 3b, that is, a first battery cell 2 and a second battery cell 3 are used as the battery cells 2 and 3. The first battery cell 2 is low in projection height H1 of the electrode 2b as shown in FIG. 4(a). The second battery cell 3 is high in projection height H2 of the electrode 3b as shown in FIG. 4(b). The stacked twelve battery cells 2 and 3 constitute, in order from the top, the first battery cell group SG1, the second battery cell group SG2 and the third battery cell group SG3. A stacked pattern of the battery cells 2 and 3 in each of the battery cell groups SG1, SG2 and SG3 will be described in detail in the following.

The one battery coupling block body 10 has an insulating case body 11, a substrate 12 disposed within a frame of the insulating case body 11, and an insulating cover 13 covering the inside of the frame of the insulating case body 11 from the outer surface side.

As shown in FIG. 2, terminal insertion holes 11a are provided in the insulating case body 11 in two places. Terminal insertion holes 14 are provided also in the substrate 12 at the same positions as the terminal insertion holes 11a in the insulating case body 11.

A circuit pattern part for voltage detection (not shown) is formed on the substrate 12. The circuit pattern part respectively has an electrode land part 15 near each of the terminal insertion holes 14. A through-hole 12a is formed in the substrate 12 at the position of each of the electrode land parts 15. One pair of fixing holes 12b are formed at left and right positions of this through-hole 12a.

The insulating cover 13 is constituted by four split cover parts 13a to 13d. The split cover parts 13a and 13d at its both ends are mounted onto the insulating case body 11. The central two split cover parts 13b and 13c are respectively supported rotatably by the split cover parts 13a and 13d at the both ends. When the central two split cover parts 13b and 13c are set to open positions, the outer surface side of the substrate 12 is exposed as shown in FIG. 1 or the like. When the central two split cover parts 13b and 13c are set to closed positions, they cover the outer surface side of the substrate 12 as shown in FIG. 10. In the closed positions, the central two split cover parts 13b and 13c are mounted onto the insulating case body 11. Thereby, the one battery coupling block body 10 insulates the electrodes 2b and 3b which project to the one side of the battery assembly 1.

The other battery coupling block body 20 has substantially the same configuration as the one battery coupling block body 10, and has an insulating case body 21, a substrate (not shown) and an insulating cover 22. The other battery coupling block body 20 insulates the electrodes 2b and 3b which project to the other side of the battery assembly 1. The voltage of each electrode obtained from the side of the other battery coupling block body 20 is guided to the substrate 12 of the one battery coupling block body 10 via the flat cable 40.

Next, a connection structure of each of the electrodes 2b and 3b of the battery cells 2 and 3 and the circuit pattern part for voltage detection (not shown) of the substrate 12 will be described. This connection structure uses a first battery-side-relay terminal 16, a second battery-side-relay terminal 17, a substrate-side-relay terminal 18 and a clip 19. The first battery-side-relay terminal 16 is formed by a bus bar made up of an electrically conductive metal as shown in detail in FIG. 5(a). The first battery-side-relay terminal 16 includes two electrode connection parts 16a and 16b arranged in parallel at intervals, a coupling part 16c for coupling these two electrode connection parts 16a and 16b, and a tab part 16d projecting from the one electrode connection part 16a, and has substantially an inverted C-shape. Electrode insertion holes 16e are respectively formed, in the coupling part 16c, at positions near inner surfaces of the respective electrode connection parts 16a and 16b. The electrodes 2b and 3b can be inserted into the inner surface side of each of the electrode connection parts 16a and 16b by utilizing each of these electrode insertion holes 16e. Therefore, the electrodes 2b and 3b can be arranged on both surfaces of each of the electrode connection parts 16a and 16b.

The second battery-side-relay terminal 17 is formed by a bus bar made up of an electrically conductive metal as shown in detail in FIG. 5(b). The second battery-side-relay terminal 17 includes a single electrode connection part 17a, and a tab part 17b projected from this electrode connection part 17a, and has a flat shape. The electrodes 2b and 3b can be arranged on both surfaces of the electrode connection part 17a.

The substrate-side-relay terminal 18 is formed by a bus bar made of an electrically conductive metal as shown in FIGS. 6(a) and 6(b). The substrate-side-relay terminal 18 includes a base plate part 18a, one pair of substrate insertion plate parts 18b bent from both side ends of this base plate part 18a, a substrate connection pin part 18c bent from a central position of the base plate part 18a and projecting in the same direction as the substrate insertion plate parts 18b, and a tab part 18d bent from an upper end of the base plate part 18a. As shown in FIG. 7, the one pair of substrate insertion plate parts 18b are inserted into the fixing holes 12b in the substrate 12, and the substrate connection pin part 18c is inserted into the through-hole 12a in the substrate 12. Then, the substrate connection pin part 18c and the electrode land part 15 of the circuit pattern part for voltage detection are connected by soldering.

The clip 19 is formed by an electrically conductive metal material as shown in detail in FIG. 5(c). The clip 19 has one pair of clamping arm parts 19a.

As shown in FIG. 2, there are cases where the first battery-side-relay terminal 16 and the substrate-side-relay terminal 18 are to be inserted, in pairs, into between the one pair of clamping arm parts 19a and where the second battery-side-relay terminal 17 and the substrate-side-relay terminal 18 are to be inserted in pairs.

When the first battery-side-relay terminal 16 and the substrate-side-relay terminal 18 are to be inserted, in pairs, into between the one pair of clamping arm parts 19a, the clip 19 sandwiches the tab part 16d of the first battery-side-relay terminal 16 and the tab part 18d of the substrate-side-relay terminal 18 and closely connects together the both tab parts 16d and 18d. The mounted clip 19 can be detached by separating it from the both tab parts 16d and 18d.

When the second battery-side-relay terminal 17 and the substrate-side-relay terminal 18 are to be inserted, in pairs, into between the one pair of clamping arm parts 19a in pairs, the clip 19 sandwiches the tab part 17b of the second battery-side-relay terminal 17 and the tab part 18d of the substrate-side-relay terminal 18 and closely connects together the both tab parts 17b and 18d. The mounted clip 19 can be detached by separating it from the both tab parts 17b and 18d.

Next, a stacking pattern of the battery cells 2 and 3 will be described. The stacked twelve battery cells 2 and 3 constitute, in order from the top, the first battery cell group SG1, the second battery cell group SG2 and the third battery cell group SG3. In the four battery cells 2 and 3 in each of the battery cell groups, the inner two are the first battery cells 2 and the outer two are the second battery cells 3. The battery cells 2 and 3 are stacked in an array in which the mutually facing electrodes 2b and 3b have the same polarity and directions where the mutual electrodes 2b and 3b project are mutually facing directions, such that the four battery cells 2 and 3 in each of the battery cell groups are mutually parallel-connected.

Therefore, as shown in FIG. 2, on one side of the first battery cell group SG1, on the basis of the position of the electrode connection part 17a of the second battery-side-relay terminal 17, the electrodes 2b and 3b of the battery cells 2 and 3 arranged on the upper side (one side) are arranged in an overlapping manner on an upper surface (one surface) of the electrode connection part 17a, and the electrodes 2b and 3b of the battery cells 2 and 3 arranged on the lower side (the other side) are arranged in an overlapping manner on a lower surface (the other surface) of the electrode connection part 17a.

On one side of the second battery cell group SG2, on the basis of the position of the electrode connection part 16a of the first battery-side-relay terminal 16, the electrodes 2b and 3b of the battery cells 2 and 3 arranged on the upper side (one side) are arranged in an overlapping manner on an upper surface (one surface) of the electrode connection part 16a, and the electrodes 2b and 3b of the battery cells 2 and 3 arranged on the lower side (the other side) are arranged in an overlapping manner on a lower surface (the other surface) of the electrode connection part 16a.

On one side of the third battery cell group SG3, on the basis of the position of the electrode connection part 16b of the first battery-side-relay terminal 16, the electrodes 2b and 3b of the battery cells 2 and 3 arranged on the upper side (one side) are arranged in an overlapping manner on an upper surface (one surface) of the electrode connection part 16b, and the electrodes 2b and 3b of the battery cells 2 and 3 arranged on the lower side (the other side) are arranged in an overlapping manner on a lower surface (the other surface) of the electrode connection part 16b.

On the other sides of the first battery cell group SG1 and the second battery cell group SG2, although not shown in the drawings, the respective electrodes 2b and 3b are respectively arranged, in the same states as the above, on the respective electrode connection parts 16a and 16b of the first battery-side-relay terminal 16, and on the other side of the third battery cell group SG3, the respective electrodes 2b and 3b are respectively arranged, in the same states as the above, on the electrode connection part 17a of the second battery-side-relay terminal 17.

Owing to the above arrangement, the cell groups SG1, SG2 and SG3 reach a series-connected state.

The first and second battery-side-relay terminals 16 and 17 and the plurality of electrodes 2b and 3b are connected by welding or the like.

Information on voltages of electrode positions on the both sides of each of the battery cells 2 and 3 is guided to the substrate 12. Then, presence/absence of abnormality relating to an output voltage or the like of each of the battery cells 2 and 3 is determined on the basis of these pieces of information.

In addition, one pair of output terminals 30 and 31 is provided on the respective insulating case bodies 11 and 21 of the one pair of battery coupling block bodies 10 and 20. An output of the power supply device A is obtained from the one pair of output terminals 30 and 31.

Next, an outline of assembling work of the power supply device A will be described. The first and second battery-side-relay terminals 16 and 17 are connected to gathering spots of the electrodes 2b and 3b of the battery assembly 1. Description will be made assuming that the substrate-side-relay terminal 18 is connected to the substrate 12.

The one battery coupling block body 10 is brought near from a direction confronting one side of the battery assembly 1, the first battery-side-relay terminal 16 is inserted into the terminal insertion hole 11a in the insulating case body 11 and the terminal insertion hole 14 in the substrate 12, and simultaneously, the second battery-side-relay terminal 17 is inserted into the terminal insertion hole 11a in the insulating case body 11 and the terminal insertion hole 14 in the substrate 12. Thereby, each of the tab parts 16d and 17b of the first and second battery-side-relay terminals 16 and 17 is projected to the outer surface side of the substrate 12 and is arranged at a position close to or a position near each tab part 18d of the substrate-side-relay terminal 18 (see FIGS. 8(a) and 8(b)). Next, a set of the tab part 16d of the first battery-side-relay terminal 16 and the tab part 18d of the substrate-side-relay terminal 18 and a set of the tab part 17b of the second battery-side-relay terminal 17 and the tab part 18d of the substrate-side-relay terminal 18 are respectively sandwiched by the clips 19, and the clips 19 is mounted (see FIGS. 9(a) and 9(b)). Next, the central split cover parts 13b and 13c are set to closed positions to cover the substrate 12 in the insulating case body 11 with the insulating cover 13 (see FIG. 10).

Assembling of the other battery coupling block body 20 can be performed by substantially the same work as that for assembling of the one battery coupling block body 10, and thus the work is completed.

As described above, the power supply device A includes the battery assembly 1, the battery coupling block bodies 10 and 20 disposed on the sides of the battery assembly 1 where the electrodes 2b and 3b are projected and having the substrates 12 provided with the circuit pattern parts for voltage detection and provided with the terminal insertion holes 14, the first and second battery-side-relay terminals 16 and 17 which are connected to the electrodes 2b and 3b of the battery cells 2 and 3 and the tab parts 16d and 17b of which are projected to the outer surface side of the substrate 12 through the terminal insertion holes 14, the substrate-side-relay terminal 18 which is connected to the circuit pattern part for voltage detection and the tab part 18d of which is projected to the outer surface side of the substrate 12, and the clips 19 clamping the tab parts 16d and 17b, and 18d of both of the battery-side-relay terminal 16 and 17, and the substrate-side-relay terminal 18, to bring the tab parts 16d and 17b, and 18d of the both into contact with each other.

Therefore, when the clips 19 are detached, connections between the first and second battery-side-relay terminals 16 and 17, and the substrate-side-relay terminal 18 are released and the first and second battery-side-relay terminals 16 and 17 can be pulled out of the terminal insertion holes 14 in the substrate 12, and thus the assembled state of the battery assembly 1 and the battery coupling block bodies 10 and 20 can be released. When the battery assembly 1 and the battery coupling block bodies 10 and 20 are to be assembled, the assembling can be performed by the work which is substantially opposite to the above. Owing to the above, the battery assembly 1 and the battery coupling block bodies 10 and 20 can be easily replaced separately.

Since the mounting position of the clip 19 is on the outside of the substrate 12, the work of mounting/detaching the clip 19 can be facilitated.

Since the electrodes 2b and 3b in each of the battery cell groups SG1 to SG3 are divided and arranged on the both surfaces of the electrode connection part, the pile up number of the electrodes 2b and 3b is reduced, and thus labor required for connection between the electrode connection part and the electrodes 2b and 3b in each of the battery cell groups SG1 to SG3 can be reduced.

Although the number of the battery cells 2 and 3 in the battery cell groups SG1 to SG3 is four, the number of the battery cells 2 and 3 in the battery cell groups SG1 to SG3 may be the number (one is included) other than four.

The first battery-side-relay terminal 16 has the two electrode connection parts 16a and 16b which are coupled via the coupling part 16c. Therefore, the mutual battery cells 2 and 3 in two battery cell groups (a combination of SG2 and SG3, and a combination of SG1 and SG2) can be respectively parallel-connected, and the two battery cell groups (the combination of SG2 and SG3, and the combination of SG1 and SG2) can be series-connected.

Although the first battery-side-relay terminal 16 has the two electrode connection parts 16a and 16b, it may have three or more electrode connection parts 16a and 16b.

The electrode insertion hole 16e which opens on the inner surface side of each of the electrode connection parts 16a and 16b is provided in the coupling part 16c. Therefore, the electrodes 2b and 3b can be inserted from the outer surface side of the coupling part 16c, and thus connection workability (for example, welding workability) between the first battery-side-relay terminal 16 and the electrodes 2b and 3b is good.

The present application claims priority based on Japanese Patent Application No. 2012-086500, filed on Apr. 5, 2012, the content of which is hereby incorporated by reference into the present application.

### INDUSTRIAL APPLICABILITY

According to the present invention, when the clip is detached, connection between the substrate-side-relay terminal and the battery-side-relay terminal is released and the battery-side-relay terminal can be pulled out of the terminal insertion hole in the substrate, and thus the assembled state of the battery assembly and the battery coupling block bodies can be released. The assembling of the battery assembly and the battery coupling block bodies can be performed by the work which is substantially opposite to the above. Owing to the above, the battery assembly and the battery coupling block bodies can be easily replaced separately.

### REFERENCE SIGNS LIST

A power supply device
2, 3 battery cell
2b, 3b electrode
10, 20 battery coupling block body
12 substrate
14 terminal insertion hole
16 first battery-side-relay terminal
16a, 16b, 17a electrode connection part
16c coupling part
16e electrode insertion hole
17 second battery-side-relay terminal
18 substrate-side-relay terminal
19 clip

1. A power supply device, comprising:
a battery assembly in which a plurality of battery cells having electrodes projected is stacked;
a battery coupling block body disposed on a side of the battery assembly where the electrodes are projected and having a substrate provided with a circuit pattern part for voltage detection and provided with a terminal insertion hole;
a battery-side-relay terminal connected to the electrodes of the battery cells and projected from the terminal insertion hole to an outer surface side of the substrate;
a substrate-side-relay terminal connected to the circuit pattern part for voltage detection and projected to the outer surface side of the substrate; and
a clip clamping both of the battery-side-relay terminal and the substrate-side-relay terminal.

2. The power supply device according to claim 1, wherein the battery-side-relay terminal has an electrode connection part, and the electrodes are respectively fixed to both surfaces of the electrode connection part.

3. The power supply device according to claim 2, wherein
the battery-side-relay terminal has a plurality of the electrode connection parts coupled by a coupling part, and
the electrodes of the battery cells are respectively connected to the respective electrode connection parts.

4. The power supply device according to claim 3, wherein
electrode insertion holes which open on inner surface sides of the respective electrode connection parts are formed in the coupling part.
